(19) United States
(12) Patent Application Publication
(10) Pub. No.: US 2023/0307761 A1
(43) Pub. Date: Sep. 28, 2023

(54) BATTERY MODULE CASE AND BATTERY MODULE COMPRISING THE SAME

(71) Applicant: SK ON CO., LTD., Seoul (KR)

(72) Inventors: Jeong Hyeon YUN, Daejeon (KR); Kyu Beom KIM, Daejeon (KR); Chae Rin RYOU, Daejeon (KR); Hyea Won YUN, Daejeon (KR); Ji Hyeon LEE, Daejeon (KR); Jong Chan IM, Daejeon (KR)

(21) Appl. No.: 18/178,530

(22) Filed: Mar. 6, 2023

(30) Foreign Application Priority Data
Mar. 22, 2022 (KR) 10-2022-0035658

(51) Int. Cl. H01M 50/242; H01M 50/262; H01M 50/271; H01M 50/209

(52) U.S. Cl. CPC H01M 50/242; H01M 50/262; H01M 50/271; H01M 50/209

(57) ABSTRACT

A battery module case according to an embodiment of the present disclosure includes a plurality of end plates spaced apart from each other in a horizontal direction to accommodate a plurality of battery cells, a cover disposed on one surface of each of the plurality of end plates and having at least one hole extending in the horizontal direction formed therein, and a coupling part coupled to one of the plurality of end plates through the at least one hole.

### CROSS-REFERENCE TO RELATED APPLICATION

The present application claims priority under 35 U.S.C. § 119(a) to Korean patent application number 10-2022-0035658 filed on Mar. 22, 2022, in the Korean Intellectual Property Office, the entire disclosure of which is incorporated by reference herein.

### BACKGROUND

### 1. Technical Field

The present disclosure relates to a battery module case and a battery module including the same.

### 2. Related Art

With development of electronics, communications, and space industries, the demand for secondary batteries as an energy power source is rapidly increasing. In particular, the demand for high-energy density batteries is increasing, and research on battery modules is actively underway.

The battery module may include one or more battery cells and a battery module case for protecting the battery cells. Generally, the battery module case has a structure surrounding the battery cell. Meanwhile, depending on the use environment (cycle, etc.) of the battery cell, the volume of the battery cell may expand, which may cause damage to the battery module case or battery cell. There is an issue in that manufacturing cost or weight may increase when using a material that reinforces the strength of the battery module case or battery cell, so another approach is required.

### SUMMARY

Embodiments provide a battery module case capable of preventing deformation or damage due to swelling inside the battery module (for example, due to swelling of a battery cell) and a battery module including the same.

In accordance with an aspect of the present disclosure, there is provided a battery module case, including a plurality of end plates spaced apart from each other in a horizontal direction to accommodate a plurality of battery cells, a cover disposed on one surface of each of the plurality of end plates and having at least one hole extending in the horizontal direction formed therein, and a coupling part coupled to one of the plurality of end plates through the at least one hole.

In an embodiment, when a pressure equal to or greater than a reference value is applied to the plurality of end plates in the horizontal direction, a distance between the plurality of end plates may be changed.

In an embodiment, when a pressure equal to or greater than a reference value is applied to the plurality of end plates in the horizontal direction, a location of the coupling part may be changed in the at least one hole.

In an embodiment, the coupling part may include a body and a head having a larger area than the body, the body may pass through the at least one hole and may be coupled to a fixing hole formed in one of the plurality of end plates, and the head may be in contact with a peripheral area of the at least one hole.

In an embodiment, the peripheral area may have a different coefficient of friction depending on a location in the horizontal direction.

In an embodiment, the peripheral area may have a larger coefficient of friction as the location is farther from a center location of the cover.

In an embodiment, the cover may include an upper cover and a lower cover, the upper cover may be configured to surround a top surface, a portion of a front surface, and a portion of a rear surface of each of the plurality of end plates, and the lower cover may be configured to surround a bottom surface, another portion of the front surface, and another portion of the rear surface of each of the plurality of end plates.

In an embodiment, at least one of the plurality of end plates may include a bump formed on one surface different from the one surface, the cover may include a plurality of recessed parts disposed in the horizontal direction, and the bump may be accommodated in one of the plurality of recessed parts.

In an embodiment, when a pressure equal to or greater than a reference value is applied to the plurality of end plates in the horizontal direction, the bump may be accommodated in another one of the plurality of recessed parts.

In accordance with an aspect of the present disclosure, there is provided a battery module including a plurality of battery cells stacked in one direction, a plurality of end plates disposed on both ends of the plurality of battery cells, a cover disposed on one surface of each of the plurality of end plates and having at least one hole extending in the one direction formed therein, and a coupling part coupled to one of the plurality of end plates through the at least one hole.

In an embodiment, when a pressure equal to or greater than a reference value is applied to the plurality of end plates in the one direction, a distance between the plurality of end plates may be changed.

In an embodiment, the reference value may be a value included in a range of 10 kN or more and less than 40 kN.

In an embodiment, when at least one of the plurality of battery cells expands, a location of the coupling part may be changed in the at least one hole.

In an embodiment, the coupling part may include a body and a head having a larger area than the body, the body may pass through the at least one hole and may be coupled to a fixing hole formed in one of the plurality of end plates, and the head may be in contact with a peripheral area of the at least one hole.

In an embodiment, the peripheral area may have a different coefficient of friction depending on a location in the one direction.

In an embodiment, at least one of the plurality of end plates may include a bump formed on one surface different from the one surface, the cover may include a plurality of recessed parts disposed in the one direction, and the bump may be accommodated in one of the plurality of recessed parts.

In an embodiment, when at least one of the plurality of battery cells expands, the bump may be accommodated in another one of the plurality of recessed parts.

According to an embodiment of the present disclosure, it is possible to provide a battery module case capable of preventing deformation or damage due to swelling inside a battery module, for example, due to swelling of a battery cell, and a battery module including the same. In addition, it is possible to improve cycle performance of a battery cell by automatically adjusting the pressure applied to the battery cell.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram for explaining a battery module in accordance with an embodiment of the present disclosure.

FIG. 2 is a diagram for explaining a battery module case in accordance with an embodiment of the present disclosure.

FIG. 3 is a diagram for explaining a battery module case in accordance with an embodiment of the present disclosure.

FIG. 4 is a diagram for explaining a battery module in accordance with an embodiment of the present disclosure.

FIG. 5 is a diagram for explaining an initial state of a battery module in accordance with an embodiment of the present disclosure.

FIG. 6 is a diagram for explaining a later state of a battery module in accordance with an embodiment of the present disclosure.

FIG. 7 is a diagram for explaining a bump in accordance with an embodiment of the present disclosure.

FIG. 8 is a diagram for explaining a battery cell in accordance with an embodiment of the present disclosure.

FIG. 9 is a diagram for explaining a battery cell in accordance with an embodiment of the present disclosure.

### DETAILED DESCRIPTION

The specific structural or functional description disclosed herein is merely illustrative for the purpose of describing embodiments according to the concept of the present disclosure. The embodiments according to the concept of the present disclosure can be implemented in various forms, and cannot be construed as limited to the embodiments set forth herein.

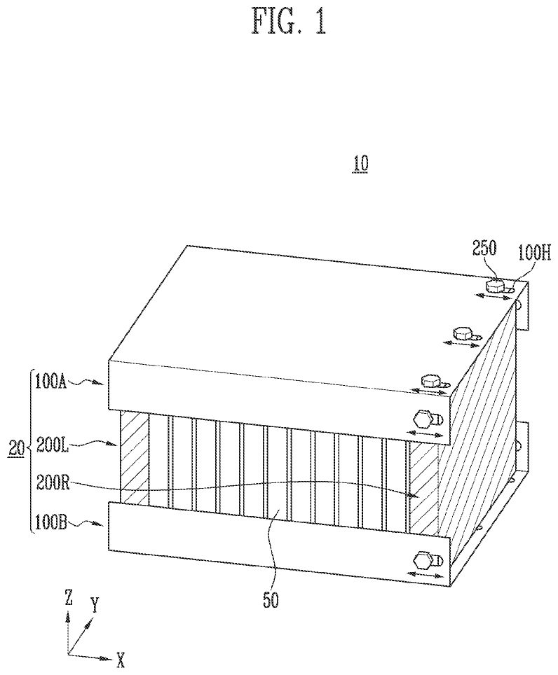

FIG. 1 is a diagram for explaining a battery module in accordance with an embodiment of the present disclosure.

Referring to FIG. 1, a battery module 10 according to an embodiment of the present disclosure may include at least one battery cell 50 and a battery module case 20. The battery module 10 may supply power to various electronic devices.

The battery cell 50 may be the smallest unit of a battery capable of charging and discharging. For example, the battery cell 50 may be composed of a battery such as a lithium ion battery, a lithium ion polymer battery, a nickel cadmium battery, a nickel zinc battery, and the like. The number of battery cells 50 may be one or plural. When there are a plurality of battery cells 50, they may be electrically connected to each other in series or parallel.

The battery cell 50 may be accommodated in the internal space of the battery module case 20. In an embodiment, the plurality of battery cells 50 may be stacked in one direction. For example, one direction may be a horizontal direction. Specifically, the plurality of battery cells 50 may be disposed in a horizontal direction in the internal space of the battery module case 20. Here, the horizontal direction may be the X-axis direction. The plurality of battery cells 50 may be disposed parallel to each other. In an embodiment, auxiliary materials such as a buffer material and a cooling plate may be inserted between the plurality of battery cells 50.

The battery module case 20 may accommodate at least one battery cell 50 in an internal accommodating space. The battery module case 20 may protect the battery cell 50 from the external environment. For example, the external environment may be heat, moisture, foreign matter, and impact.

The battery module case 20 may include covers 100A and 100B, end plates 200L and 200R, and a coupling part 250.

The covers 100A and 100B may be disposed on one surface of each of the end plates 200L and 200R. The covers 100A and 100B may be coupled to the end plates 200L and 200R. In an embodiment, the covers 100A and 100B may be a plate-like structure of one plane. In an embodiment, the covers 100A and 100B may have a structure in which several planes are joined or coupled to each other. In an embodiment, the covers 100A and 100B may have a convex or concave surface structure. However, this is only an embodiment, and the covers 100A and 100B may have various structures for forming the accommodating space for the battery cell 50 by coupling with the end plates 200L and 200R.

At least one hole 100H may be formed in the covers 100A and 100B. The hole 100H may be a long hole extending in the first direction. For example, the long hole may be a shape whose length in the horizontal direction is longer than the length in the vertical direction or the length in the height direction. The horizontal direction may be a direction in which the end plates 200L and 200R are spaced apart. Here, the horizontal direction may be the X-axis direction, the vertical direction may be the Y-axis direction, and the height direction may be the Z-axis direction. In an embodiment, the long hole may have a structure through which one side and the other side of the cover 100A, 100B are penetrated.

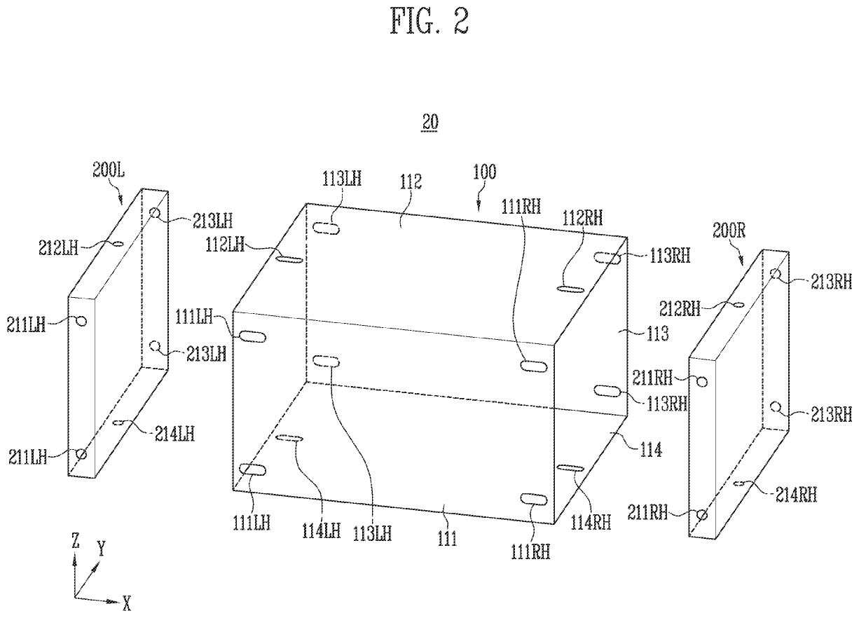

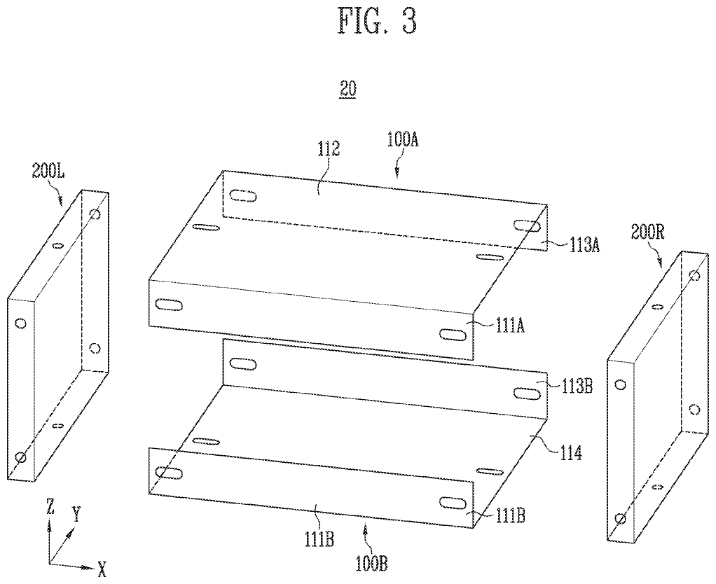

In an embodiment, the covers 100A and 100B may include an upper cover 100A and a lower cover 100B as shown in FIGS. 1 and 3. However, this is only an embodiment, and the covers 100A and 100B may be deformed into various shapes, such as an integral cover 100 of FIG. 2.

The end plates 200L and 200R may be spaced apart from each other in a horizontal direction to accommodate the battery cell 50. In other words, the end plates 200L and 200R may be spaced apart from each other in a horizontal direction to form an accommodating space for the battery cell 50. Here, the horizontal direction may be the X-axis direction. For example, the shape of the end plates 200L and 200R may be longer on the Y-axis and Z-axis than on the X-axis. The shape of the end plates 200L and 200R may be a hexahedron, but is not limited thereto and may be deformed into various shapes such as a disk shape.

The end plates 200L and 200R may be disposed at both ends of the battery cell 50. For example, one of the end plates 200L and 200R may be disposed on one end of the battery cell 50, and the other of the end plates 200L and 200R may be disposed on the other end of the battery cell 50.

Specifically, the end plates 200L and 200R may include a first end plate 200L and a second end plate 200R. For example, both ends may include a left end and a right end in the X-axis direction. In this case, the first end plate 200L may be disposed on the left end of the battery cell 50 and the second end plate 200R may be disposed on the right end of the battery cell 50. When the number of battery cells 50 is plural, the first end plate 200L may be disposed on the left end of the entire battery cells 50, and the second end plate 200R may be disposed on the right end of the entire battery cells 50.

The coupling part 250 may be coupled to one of the end plates 200L and 200R through the hole 100H. Specifically, the coupling part 250 may couple one of the end plates 200L and 200R and the cover 100A, 100B to each other through the hole 100H. For example, a portion of the coupling part 250 may pass through the hole 100H and be fixed to the end plates 200L and 200R. Another portion of the coupling part 250 may contact the peripheral area of the hole 100H. The end plates 200L and 200R and the covers 100A and 100B may be coupled to each other by frictional force between the coupling part 250 and the peripheral area of the hole 100H. For example, the coupling part 250 may be composed of bolts, nuts, or screws.

In an embodiment, each of the end plates 200L and 200R may be coupled to the cover 100A, 100B by a coupling part 250 through a hole 100H. For example, a hole for coupling the first end plate 200L and a hole for coupling the second end plate 200R may be formed in the covers 100A and 100B.

In another embodiment, one of the end plates 200L and 200R may be coupled to the cover 100A, 100B by a coupling part 250 through a hole 100H. In this case, another one of the end plates 200L and 200R may be coupled to the cover 100A, 100B by welding or screwing.

When manufacturing the battery module 10, the end plates 200L and 200R may be coupled to the cover 100A, 100B using the coupling part 250 so that the end plates 200L and 200R apply pressure to the battery cell 50 in the horizontal direction. Here, the magnitude of the pressure may be included in the initial reference range value. In addition, the end plates 200L and 200R may be coupled to the cover 100A, 100B by the pressure. The initial reference range value may be preset. Meanwhile, the end plates 200L and 200R may receive pressure from the battery cell 50 in the horizontal direction by the reaction.

Meanwhile, swelling may occur in the battery cell 50 depending on the use environment. For example, swelling may refer to a phenomenon in which the volume of the battery cell 50 expands due to vaporization of the electrolyte inside the battery cell 50. For example, the use environment may be a use cycle, overcharge, overdischarge, high temperature, short circuit, static electricity, foreign matter, impact, or aging. The battery cell 50 in which swelling occurs may expand in volume and apply pressure in the horizontal direction to the end plates 200L and 200R. In other words, when swelling occurs in the battery cell 50, pressure applied to the end plates 200L and 200R may increase.

The end plates 200L and 200R of the present disclosure may move when pressure is applied in the horizontal direction. Specifically, when a pressure equal to or greater than a reference value is applied to the end plates 200L and 200R in a horizontal direction, the locations of the end plates 200L and 200R may be changed. In other words, the distance between the end plates 200L and 200R may be changed. Here, the coupling part 250 may move within the hole 100H. In other words, the location of the coupling part 250 in the hole 100H may be changed by moving the coupling part 250 in the horizontal direction. Here, the reference value may be a value corresponding to the frictional force.

The reference value may be set according to the pressure caused by swelling of the battery cell 50, the strength and failure load of the end plates 200L and 200R, and the lifespan and stability of the battery cell 50. In an embodiment, the pressure of the battery cell 50 due to swelling may gradually increase according to the cycle. For example, when the cycle of the battery cell 50 reaches end of life (EoL), the pressure applied to the battery cell 50 may be 40 kN. In this case, in order to prevent destruction of the end plates 200L and 200R, the reference value may be set to a value within a range of 0 kN or more and less than 40 kN. In addition, since the surface pressure affects the lifespan and stability of the battery cell 50, the reference value may be set to be greater than or equal to a specific value. In a preferred embodiment, the reference value may be a value included in the range of 10 kN or more and less than 40 kN. However, the aforementioned reference value is only an example, and may be modified to various values.

In an embodiment, the pressure applied to the end plates 200L and 200R by the battery cell 50 may be reduced by changing the distance between the end plates 200L and 200R. Due to this, deformation or damage of the battery module case 20 can be prevented. In addition, the cycle performance of the battery cell may be improved by reducing the pressure applied to the battery cell 50 by the battery module case 20.

FIG. 2 is a diagram for explaining a battery module case in accordance with an embodiment of the present disclosure.

Referring to FIG. 2, the battery module case 20 according to an embodiment of the present disclosure may include the cover 100 and the end plates 200L and 200R. FIG. 2 shows the cover 100 and the end plates 200L and 200R separated.

In an embodiment, the cover 100 may have a structure surrounding the front, rear, top and bottom surfaces of each of the end plates 200L and 200R. To this end, the cover 100 may include a front cover 111, a rear cover 113, a top cover 112 and a bottom cover 114. Specifically, the front cover 111 may be a part surrounding the front surface of each of the end plates 200L and 200R, the rear cover 113 may be a part surrounding the rear surface of each of the end plates 200L and 200R, the top cover 112 may be a part surrounding the top surface of each of the end plates 200L and 200R, the bottom cover 114 may be a part surrounding the bottom surface of each of the end plates 200L and 200R.

The front cover 111 and the rear cover 113 may be spaced apart from each other in a vertical direction. For example, the vertical direction may be the Y-axis direction. The top cover 112 and the bottom cover 114 may be spaced apart from each other in a height direction. For example, the height direction may be the Z-axis direction.

The end plates 200L and 200R may include a first end plate 200L and a second end plate 200R. The first end plate 200L and the second end plate 200R may be spaced apart from each other in a horizontal direction. For example, the horizontal direction may be the X-axis direction.

In the first end plate 200L, fixing holes 211LH, 212LH, 213LH, and 214LH may be formed. For example, the fixing holes 211LH, 212LH, 213LH, 214LH of the first end plate 200L may include a fixing hole 211LH formed on the front surface of the first end plate 200L, a fixing hole 213LH formed on the rear surface of the first end plate 200L, a fixing hole 212LH formed on the top surface of the first end plate 200L, and a fixing hole 214LH formed on the bottom surface of the first end plate 200L.

In the second end plate 200R, fixing holes 211RH, 212RH, 213RH, and 214RH may be formed. For example, the fixing holes 211RH, 212RH, 213RH, and 214RH of the second end plate 200R may include a fixing hole 211RH formed on the front surface of the second end plate 200R, a fixing hole 213RH formed on the rear surface of the second end plate 200R, a fixing hole 212RH formed on the top surface of the second end plate 200R, and a fixing hole 214RH formed on the bottom surface of the second end plate 200R.

In the front cover 111, holes 111LH, 111RH extending in the horizontal direction may be formed. In the rear cover 113, holes 113LH, 113RH extending in the horizontal direction may be formed. In the top cover 112, holes 112LH and 112RH extending in the horizontal direction may be formed. In the bottom cover 114, holes 114LH and 114RH extending in the horizontal direction may be formed.

In an embodiment, the fixing holes 211LH, 212LH, 213LH, and 214LH of the first end plate 200L and the holes 111LH, 112LH, 113LH, and 114LH of the cover 100 may be arranged to overlap at corresponding locations, and then the first end plate 200L may be coupled to the cover 100 by the coupling part 250. The fixing holes 211RH, 212RH, 213RH, and 214RH of the second end plate 200R and the holes 111RH, 112RH, 113RH, and 114RH of the cover 100 may be arranged to overlap at corresponding locations, and then the second end plate 200R may be coupled to the cover 100 by the coupling part 250.

For example, after locating the first hole 111LH of the front cover 111 on the fixing hole 211LH formed on the front surface of the first end plate 200L, the coupling part 250 may be fixed by inserting the body of the coupling part 250 into the fixing hole 211LH formed on the front surface of the first end plate 200L through the first hole 111LH. In the same manner, the end plates 200L and 200R may be coupled to the cover 100 by the coupling part 250 by overlapping the holes 112LH, 113LH, 114LH, 111RH, 112RH, 113RH, 114RH of the cover 100 corresponding to the other fixing holes 212LH, 213LH, 214LH, 211RH, 212RH, 213RH, 214RH of the end plates 200L and 200R.

In an embodiment, the length of the fixing holes 211LH, 212LH, 213LH, 214LH, 211RH, 212RH, 213RH, and 214RH of the end plates 200L and 200R in the horizontal direction may be smaller than the length of the holes 111LH, 112LH, 113LH, 114LH, 111RH, 112RH, 113RH, and 114RH of the cover 100 in the horizontal direction. In other words, the fixing holes 211LH, 212LH, 213LH, 214LH, 211RH, 212RH, 213RH, and 214RH of the end plates 200L and 200R may be short holes.

In an embodiment, the fixing holes 211LH, 212LH, 213LH, 214LH, 211RH, 212RH, 213RH, and 214RH of the end plates 200L and 200R may have a structure having a height and an area capable of accommodating the coupling part 250. The fixing holes 211LH, 212LH, 213LH, 214LH, 211RH, 212RH, 213RH, and 214RH of the end plates 200L and 200R may have threads for fixing the coupling part 250.

Meanwhile, the number and locations of the holes 111LH, 112LH, 113LH, 114LH, 111RH, 112RH, 113RH, and 114RH corresponding to the above-described fixing holes 211LH, 212LH, 213LH, 214LH, 211RH, 212RH, 213RH, and 214RH are only examples and may be modified in various ways.

FIG. 3 is a diagram for explaining a battery module case in accordance with an embodiment of the present disclosure.

Referring to FIG. 3, the battery module case 20 according to an embodiment of the present disclosure may include the covers 100A and 100B and the end plates 200L and 2008. FIG. 3 shows the covers 100A and 100B and the end plates 200L and 200R separately.

In an embodiment, the covers 100A and 100B may include is the upper cover 100A and the lower cover 100B. In other words, unlike FIG. 2, the cover 100A, 100B may be deformed into separate structures such as the upper cover 100A and the lower cover 100B.

The upper cover 100A may have a structure that surrounds a top surface, a portion of the front surface, and a portion of the rear surface of each of the end plates 200L and 200R. The lower cover 100B may have a structure that surrounds the bottom surface, another portion of the front surface, and another portion of the rear surface of each of the end plates 200L and 200R.

To this end, the upper cover 100A may include a first front cover 111A, a first rear cover 113A, and the top cover 112. The lower cover 100B may include a second front cover 111B, a second rear cover 113B, and the bottom cover 114.

Specifically, the first front cover 111A may be a portion surrounding a portion of the front surface of each of the end plates 200L and 200R, the first rear cover 113 may be a portion surrounding a portion of the rear surface of each of the end plates 200L and 200R, and the top cover 112 may be a portion surrounding the top surface of each of the end plates 200L and 200R. The second front cover 111B may be a portion surrounding another portion of the front surface of each of the end plates 200L and 200R, the second rear cover 113B may be a portion surrounding another portion of the rear surface of each of the end plates 200L and 200R, and the bottom cover 114 may be a portion surrounding the bottom surface of each of the end plates 200L and 200R.

Hereinafter, for convenience of description, it is assumed that the cover has the structure of FIG. 2 and will be described.

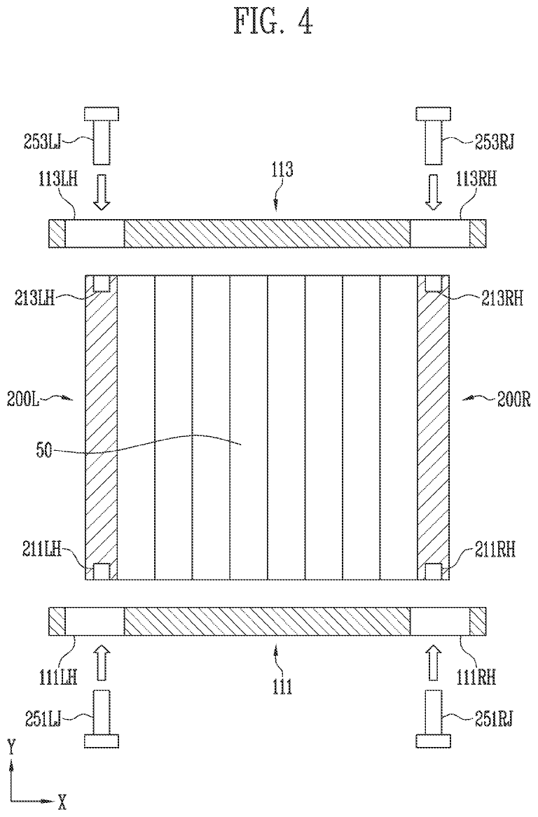

FIG. 4 is a diagram for explaining a battery module in accordance with an embodiment of the present disclosure. FIG. 4 is a cross-sectional view of the battery module 10 on the XY plane according to an embodiment.

Referring to FIG. 4, the end plates 200L and 200R may be spaced apart in the horizontal direction. A plurality of battery cells 50 may be disposed in the accommodating space formed between the end plates 200L and 200R. Fixing holes 211LH, 213LH, 211RH, and 213RH may be formed on one surface of the end plates 200L and 200R.

The front cover 111 of the cover 100 may be disposed on one surface of the end plates 200L and 200R. The front cover 111 of the cover 100 may have holes 111LH and 111RH extending in which the end plates 200L and 200R are spaced apart. The spaced apart direction is a horizontal direction, and may be, for example, an X-axis direction.

Specifically, the front cover 111 of the cover 100 may be disposed such that the first hole 111LH overlaps the first fixing hole 211LH formed on the front surface of the first end plate 200L and the second hole 111RH overlaps the second fixing hole 211RH formed on the front surface of the second end plate 200R. In addition, the first coupling part 251LJ may be inserted into the first fixing hole 211LH through the first hole 111LH and coupled to the first end plate 200L. The second coupling part 251RJ may be inserted into the second fixing hole 211RH through the second hole 111RH and coupled to the second end plate 200R.

The rear cover 113 of the cover 100 may be disposed on the other surface of the end plates 200L and 200R. The rear cover 113 of the cover 100 may have holes 113LH and 113RH extending in a direction in which the end plates 200L and 200R are spaced apart. The spaced apart direction is a horizontal direction, and may be, for example, an X-axis direction.

Specifically, the rear cover 113 of the cover 100 may be disposed such that the first hole 113LH overlaps the first fixing hole 213LH formed on the front surface of the first end plate 200L and the second hole 113RH overlaps the second fixing hole 213RH formed on the front surface of the second end plate 200R. In addition, the first coupling part 253LJ may be inserted into the first fixing hole 213LH through the first hole 113LH and coupled to the first end plate 200L. The second coupling part 253RJ may be inserted into the second fixing hole 213RH through the second hole 113RH and coupled to the second end plate 200R.

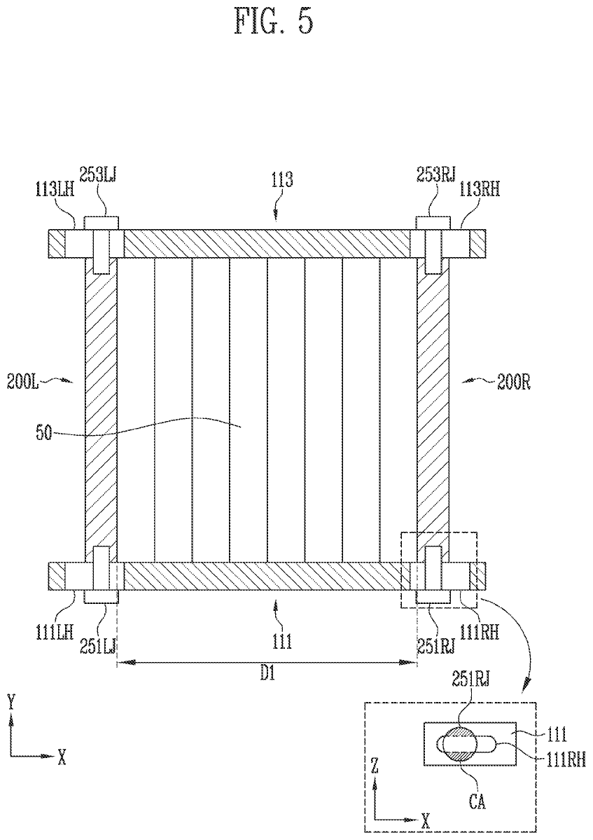

FIG. 5 is a diagram for explaining an initial state of a battery module in accordance with an embodiment of the present disclosure. FIG. 5 is a cross-sectional view of the battery module 10 on the XY plane according to an embodiment.

Referring to FIG. 5, the front cover 111 and the rear cover 113 of the cover 100 and the end plates 200L and 200R may be coupled to each other by coupling parts 251LJ, 253LJ, 251RJ, and 253RJ through holes 111LH, 113LH, 111RH, and 113RH.

In an embodiment, the coupling part 251LJ, 253LJ, 251RJ, 253RJ may include a body and a head.

The body of the coupling part 25111, 253LJ, 251RJ, 253RJ may pass through the hole 111LH, 113LH, 111RH, 113RH and be coupled to the fixing hole (211LH, 213LH, 211RH, 213RH in FIG. 4) formed in the end plate 200L, 200R.

The head of the coupling part 25111, 253LJ, 251RJ, 253RJ may contact the peripheral area of the hole 111LH, 113LH, 111RH, 113RH. The head of the coupling part 251LJ, 253LJ, 251RJ, 253RJ may have a larger area than the body. In other words, the head of the coupling part 251LJ, 253LJ, 251RJ, 253RJ may be located at a height protruding outward from the hole 111LH, 113LH, 111RH, 113RH, and may have a larger length in a direction different from the horizontal direction than that of the hole 111LH, 113LH, 111RH, 113RH.

For example, referring to the XZ plane of FIG. 5, the head of the second coupling part 251RJ may contact the peripheral area CA of the second hole 111RH in the front cover 111. The head of the second coupling part 251RJ have a larger length in the Z-axis direction different from the X-axis direction than the second hole 111RH. The front cover 111 and the second end plate 200R may be coupled due to frictional force between the peripheral area CA and the head of the second coupling part 251RJ.

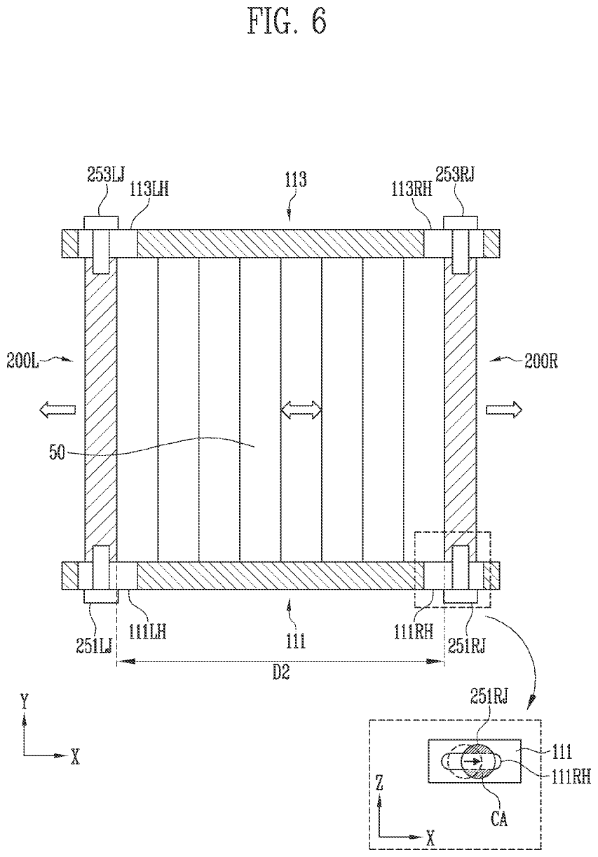

FIG. 6 is a diagram for explaining a later state of a battery module in accordance with an embodiment of the present disclosure. FIG. 6 is a cross-sectional view of the battery module 10 on the XY plane according to an embodiment.

Referring to FIG. 6, swelling may occur in the battery cell 50 and the volume of the battery cell 50 may expand in a horizontal direction. In this case, the pressure applied by the battery cell 50 to the end plates 200L and 200R may be increased.

In an embodiment, when pressure greater than a reference value is applied to the end plates 200L and 200R in a horizontal direction, the distance between the end plates 200L and 200R may be changed. Here, the reference value may be a value corresponding to the frictional force. For example, the reference value may be proportional to the coefficient of friction of the peripheral area CA.

In an embodiment, when a pressure equal to or greater than a reference value is applied to the end plates 200L and 200R in a horizontal direction, the distance between the end plates 200L and 200R may be changed from the first distance D1 of FIG. 5 to the second distance D2 of FIG. 6. The first distance D1 may be a distance in an initial state, and the second distance D2 may be a greater value than the first distance D1.

For example, the first end plate 200L may move to the left and the second end plate 200R may move to the right. As the distance between the first end plate 200L and the second end plate 200R gradually increases, the pressure may gradually decrease. When the pressure becomes less than the reference value, the movement of the first end plate 200L and the second end plate 200R may be stopped.

In an embodiment, when a pressure equal to or greater than a reference value is applied to the end plates 200L and 200R in a horizontal direction, the location of the coupling part 251LJ, 253LJ, 251RJ, 253RJ within the hole 111LH, 113LH, 111RH, 113RH may be changed. In other words, the coupling part 251LJ, 253LJ, 251RJ, 253RJ may move in the horizontal direction within the hole 111LH, 113LH, 111RH, 113RH. Here, the location may be the center location of the coupling part 251LJ, 253LJ, 251RJ, 253RJ, but this is only an example and may be specified in various locations.

For example, referring to the XZ plane of FIG. 6, when at least one of the plurality of battery cells 50 expands and a pressure equal to or greater than a reference value is applied to the end plates 200L and 200R in the horizontal direction, the second coupling part 251RJ may move in the +X-axis direction within the second hole 111RH. In this case, the second end plate 200R may move in the +X-axis direction together with the second coupling part 251RJ.

In an embodiment, the peripheral area CA may have different coefficients of friction according to locations in a spaced apart direction or a horizontal direction. The spaced apart direction or horizontal direction may be, for example, the X-axis direction.

In an embodiment, the peripheral area CA may have a larger coefficient of friction as the location is farther from the center of the cover. For example, the peripheral area CA may have a larger coefficient of friction as it moves away from the center of the front cover 111 along the X-axis direction. In this case, the coefficient of friction of the peripheral area CA located on the right side may have a greater value than that on the left side. As the coefficient of friction increases, the frictional force increases, so that a greater pressure may be required to move the end plates 200L and 200R.

In an embodiment, the peripheral area CA may have one of a first coefficient of friction and a second coefficient of friction. The second coefficient of friction may be a value greater than the first coefficient of friction. In one example, the peripheral area CA may gradually increase from a first coefficient of friction to a second coefficient of friction as the location is farther from the center of the cover. In one example, as the location of the peripheral area CA is farther from the center of the cover, an area having a first coefficient of friction and an area having a second coefficient of friction may be repeated every predetermined section.

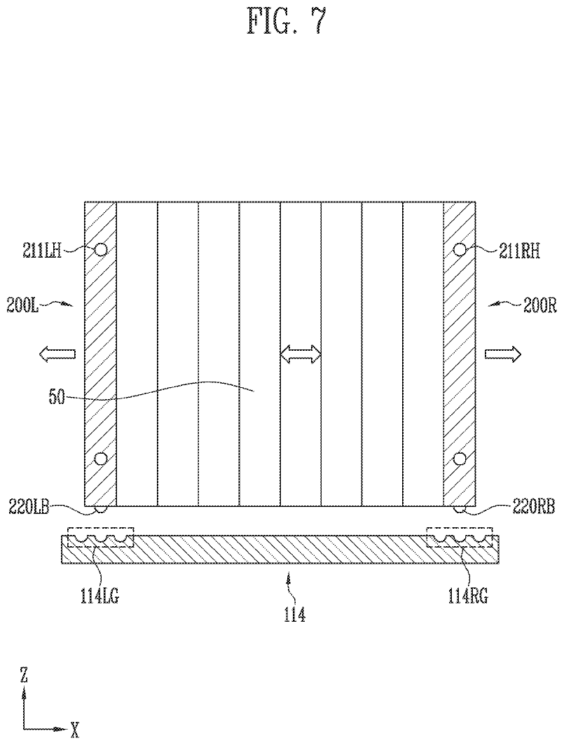

FIG. 7 is a diagram for explaining a bump in accordance with an embodiment of the present disclosure. FIG. 7 is a cross-sectional view of the battery module 10 on the XZ plane according to an embodiment.

Referring to FIG. 7, in an embodiment, a bump 220LB, 220RB formed on at least one surface of the end plates 200L and 200R may be included. Here, one surface may be another surface from the surface on which the fixing hole 211 LH, 211 RH is formed. For example, the bump 220 LB, 220 RB may be formed at the bottom surface of the end plates 200L and 200R. However, this is only an example, and bumps 220LB, 220RB may be formed on the top and bottom surfaces of the end plates 200L and 200R, respectively. The bump 220LB, 220RB may be accommodated in one of the plurality of recessed parts 114LG and 114RG formed in the cover.

The cover may include a plurality of recessed parts 114LG and 114RG disposed in the horizontal direction. For example, the bottom cover 114 may include a plurality of recessed parts 114LG, 114RG disposed in a spaced apart direction or in a horizontal direction. Here, the spaced apart direction or the horizontal direction may be the X-axis direction.

In an embodiment, when a pressure equal to or greater than a reference value is applied to the end plates 200L and 200R in a horizontal direction, the bump 220LB, 220RB may be accommodated in another one of the plurality of recessed parts 114LG, 114RG. In other words, when at least one of the plurality of battery cells 50 expands, the bump 220LB, 220RB may be accommodated in another one of the plurality of recessed parts 114LG, 114RG.

In this case, the bump 220LB, 220RB and the end plates 200L and 200R may move in stages with respect to the plurality of recessed parts 114LG, 114RG. In other words, structures such as the bump 220LB, 220RB and the recessed parts 114LG, 114RG may increase frictional force, and thus effectively brake the movement range of the end plates 200L and 200R.

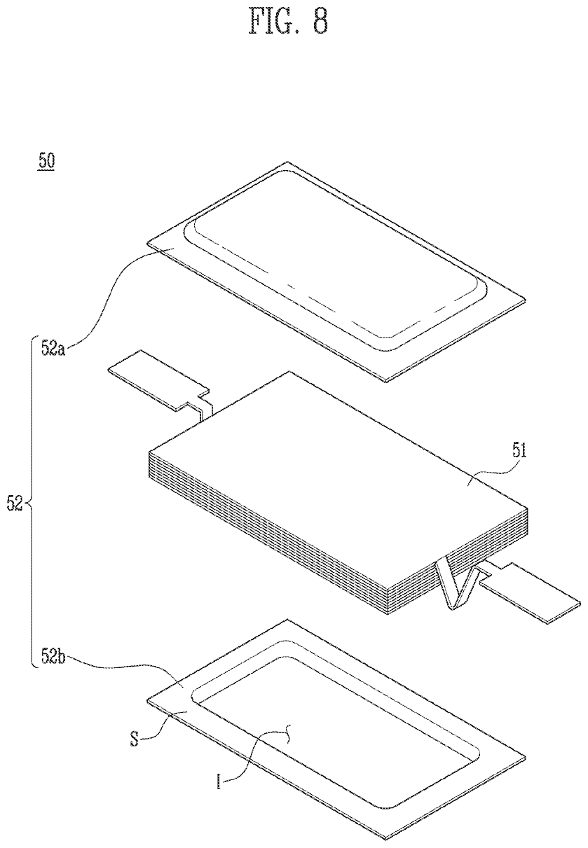

FIG. 8 is a diagram for explaining a battery cell in accordance with an embodiment of the present disclosure.

Referring to FIG. 8, a battery cell 50 according to an embodiment of the present disclosure may include an electrode assembly 51 and an exterior material 52.

The electrode assembly 51 may have a form in which one or more cathodes and one or more anodes are disposed with a separator interposed therebetween. A separator may be located between the cathode and the anode. For example, the electrode assembly 51 may have a structure in which a cathode and an anode are alternately stacked with a separator interposed therebetween.

The exterior material 52 may protect internal elements such as the electrode assembly 51. For example, the exterior material 52 may be configured to include an external insulating layer, a metal layer, and an internal adhesive layer. The exterior material 52 may be a flexible material such as a film.

The exterior material 52 may include an upper exterior material 52a and a lower exterior material 52b, and a concave internal space I may be formed in at least one of the upper exterior material 52a and the lower exterior material 52b. The electrode assembly 51 may be accommodated in the internal space I. Sealing parts S may be formed on the outer circumferential surfaces of the upper exterior material 52a and the lower exterior material 52b. The internal space I accommodating the electrode assembly 51 may be sealed by the sealing parts S coupled to each other by adhesion or the like. For example, in a state in which the electrode assembly 51 is accommodated in the internal space I of the upper exterior material 52a and the lower exterior material 52b, sealing parts S may be formed on four outer circumferential surfaces of the lower exterior material 52b that come into contact with the upper exterior material 52a.

Each electrode (cathode or anode) of the electrode assembly 51 is provided with an electrode tab, and one or more electrode tabs may be connected to an electrode lead. The electrode lead may function as an electrode terminal of the battery cell 50 by being located between the sealing parts S of the upper exterior material 52a and the lower exterior material 52b and exposed to the outside of the exterior material 52.

Meanwhile, the above-described battery cell 50 is an example of a pouch type, but this is only an example, and the battery cell 50 may be configured in a cylindrical type, a prismatic type, or the like.

For example, in the case of a cylindrical type, a structure in which a cathode, a separator, and an anode are wound so that the separator is located between the cathode and the anode may be used. For example, in the case of a cylindrical type, the exterior material may have a cylindrical shape. In the case of a prismatic type, a structure in which a cathode, a separator, and an anode are wound so that the separator is located between the anode and the cathode, or a structure in which a cathode, a separator, and an anode are stacked layer by layer may be used. For example, in the case of a prismatic type, the exterior material may have a hexahedral shape.

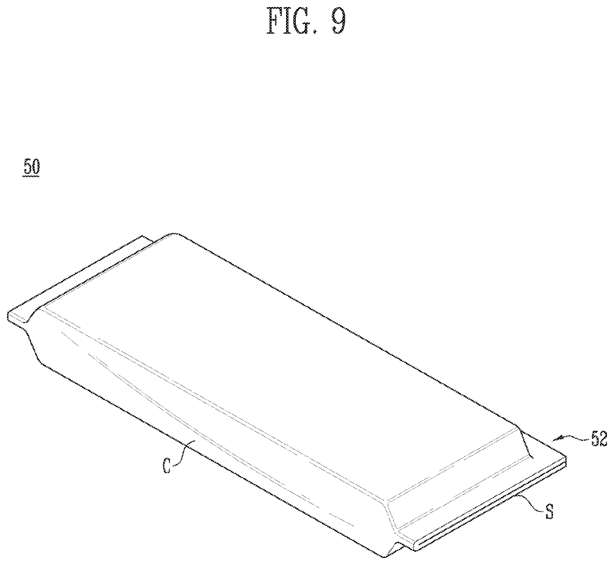

FIG. 9 is a diagram for explaining a battery cell in accordance with an embodiment of the present disclosure. FIG. 9 shows a structure that is sealed in a form different from that of FIG. 8.

Referring to FIG. 9, the battery cell 50 according to an embodiment of the present disclosure may include the exterior material 52 and an electrode assembly accommodated in an internal space of the exterior material 52.

For example, the exterior material 52 may form an internal space and four outer circumference surfaces through folding. A contact part C may be formed on one outer circumferential surface, and a sealing part S may be formed on three outer circumferential surfaces. The contact part C may be a portion where the exterior material 52 is folded. The sealing part S may be a portion in which two surfaces of the exterior material 52 are coupled to each other in a manner such as adhesion.

While the present disclosure has been shown and described with reference to certain exemplary embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described exemplary embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the exemplary embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A battery module case, comprising:
a plurality of end plates spaced apart from each other in a horizontal direction to accommodate a plurality of battery cells;
a cover disposed on one surface of each of the plurality of end plates and having at least one hole extending in the horizontal direction formed therein; and
a coupling part coupled to one of the plurality of end plates through the at least one hole.

2. The battery module case of claim 1, wherein, when a pressure equal to or greater than a reference value is applied to the plurality of end plates in the horizontal direction, a distance between the plurality of end plates is changed.

3. The battery module case of claim 1, wherein, when a pressure equal to or greater than a reference value is applied to the plurality of end plates in the horizontal direction, a location of the coupling part is changed in the at least one hole.

4. The battery module case of claim 1, wherein the coupling part comprises a body and a head having a larger area than the body, the body passes through the at least one hole and is coupled to a fixing hole formed in one of the plurality of end plates, and
the head is in contact with a peripheral area of the at least one hole.

5. The battery module case of claim 4, wherein the peripheral area has a different coefficient of friction depending on a location in the horizontal direction.

6. The battery module case of claim 5, wherein the peripheral area has a larger coefficient of friction as the location is farther from a center location of the cover.

7. The battery module case of claim , wherein the cover comprises an upper cover and a lower cover,
the upper cover is configured to surround a top surface, a portion of a front surface, and a portion of a rear surface of each of the plurality of end plates, and
the lower cover is configured to surround a bottom surface, another portion of the front surface, and another portion of the rear surface of each of the plurality of end plates.

8. The battery module case of claim 1, wherein at least one of the plurality of end plates comprises a bump formed on one surface different from the one surface,
the cover comprises a plurality of recessed parts disposed in the horizontal direction, and
the bump is accommodated in one of the plurality of recessed parts.

9. The battery module case of claim 8, wherein, when a pressure equal to or greater than a reference value is applied to the plurality of end plates in the horizontal direction, the bump is accommodated in another one of the plurality of recessed parts.

10. A battery module comprising:
a plurality of battery cells stacked in one direction;
a plurality of end plates disposed on both ends of the plurality of battery cells;
a cover disposed on one surface of each of the plurality of end plates and having at least one hole extending in the one direction formed therein; and
a coupling part coupled to one of the plurality of end plates through the at least one hole.

11. The battery module of claim 10, wherein, when a pressure equal to or greater than a reference value is applied to the plurality of end plates in the one direction, a distance between the plurality of end plates is changed.

12. The battery module of claim 11, wherein the reference value is a value included in a range of 10 kN or more and less than 40 kN.

13. The battery module of claim 10, wherein, when at least one of the plurality of battery cells expands, a location of the coupling part is changed in the at least one hole.

14. The battery module of claim 10, wherein the coupling part comprises a body and a head having a larger area than the body, the body passes through the at least one hole and is coupled to a fixing hole formed in one of the plurality of end plates, and the head is in contact with a peripheral area of the at least one hole.

15. The battery module of claim 14, wherein the peripheral area has a different coefficient of friction depending on a location in the one direction.

16. The battery module of claim 10, wherein at least one of the plurality of end plates comprises a bump formed on one surface different from the one surface, the cover comprises a plurality of recessed parts disposed in the one direction, and
the bump is accommodated in one of the plurality of recessed parts.

17. The battery module of claim 16, wherein, when at least one of the plurality of battery cells expands, the bump is accommodated in another one of the plurality of recessed parts.
